(19) United States
(12) Patent Application Publication
(10) Pub. No.: US 2010/0177011 A1
(43) Pub. Date: Jul. 15, 2010

(54) FLEXIBLE PHASED ARRAY ANTENNAS

(76) Inventors: Daniel J. Sego, Shoreline, WA (US); David L. Banks, Renton, WA (US); Manny S. Urcia, Bellevue, WA (US)

Correspondence Address: DUKE W. YEE, YEE & ASSOCIATES, P.C., P.O. BOX 802333, DALLAS, TX, 75380, US

(21) Appl. No.: 12/352,379

(22) Filed: Jan. 12, 2009

(51) Int. Cl. H01Q 21/00; H01P 11/00

(52) U.S. Cl. 343/893; 29/601

(57) ABSTRACT

A phased array antenna (PAA) is provided. The PAA includes a plurality of layers fabricated using an additive process such that the PAA conforms to a curvilinear surface. The plurality of layers include: a radiating layer placed on a first surface of a first dielectric layer; a feed layer operationally coupled to a second surface of the first dielectric layer; and a second dielectric layer having a first surface operationally coupled a power and control layer and a second surface operationally coupled to a ground layer. An adhesive layer operationally couples the feed layer to the power and control layer.

### BACKGROUND

1. Technical Field

The present disclosure relates to phased array antennas.

2. Related Art

Phased array antennas are commonly used in radar systems and communication applications for airborne or terrestrial platforms. Phased array antennas typically include a plurality of antennas. A plurality of signals is sent to the plurality of antennas. To selectively reinforce the effective radiation pattern of the antenna array, the relative phase of the signals is varied.

Phased array antennas are generally mounted on a platform that communicates with a satellite or ground station, or as illuminator and receiver in radar sensing applications. Platforms (may also be referred to as “vehicles”) include aircrafts, helicopters, satellites, automobiles and any terrestrial or airborne vehicle.

Currently, phased array antennas are commonly assembled as monolithic structures. These structures frequently take the form of multilayer printed circuit boards that are thick, heavy, and have a rigid structure. Due to the rigidity, the phased array antennas do not conform to a curvilinear surface of a platform and generally protrude out causing negative drag on the platform. The thick structure also complicates antenna integration with the platform, and increases the associated cost of producing electronics assemblies that are generally preformed to a platform's outer contour.

It is desirable to have a phased array antenna that conforms to a curvilinear surface, is thin, lightweight and flexible. Conventional phased array antennas fail to provide such characteristics.

### SUMMARY

In one embodiment, a phased array antenna (PAA) is provided. The PAA includes a plurality of layers fabricated using an additive process such that the P conforms to a curvilinear surface. The plurality of layers include: a radiating layer placed on a first surface of a first dielectric layer; a feed layer operationally coupled to a second surface of the first dielectric layer; and a second dielectric layer having a first surface operationally coupled to a power and control layer and a second surface operationally coupled to a ground layer. An adhesive layer operationally couples the feed layer to the power and control layer.

In another embodiment, a phased array antenna is provided. The phased array antenna comprises a plurality of layers fabricated using an additive process such that the phased array antenna conforms to a curvilinear surface; wherein the plurality of layers include: a radiating layer placed on a first surface of a first dielectric layer; a feed layer operationally coupled to a second surface of the first dielectric layer; and a second dielectric layer having a first surface operationally coupled to a power and control layer and a second surface operationally coupled to a ground layer; wherein an adhesive layer operationally couples the feed layer to the power and control layer; wherein the first dielectric layer and the second dielectric layer are formed of liquid crystal polymer; and wherein the radiating layer includes radiating patch elements additively deposited directly on the first surface of the first dielectric layer.

In yet another embodiment a method for fabricating a phased array antenna is provided. The method comprises (a) depositing radiating elements on a first surface of a first dielectric layer; depositing a feed layer on a second surface of the first dielectric layer; (c) depositing a power and control logic layer on a first surface of a second dielectric layer, and depositing a substrate layer on the second surface of the second dielectric layer, (d) coupling the first dielectric layer with the deposited feed layer and radiating elements of step (b) with the second dielectric layer, such that a surface of the feed layer couples to a surface of the power and control logic layer with a structural adhesive to form a multi-layer structure; and (e) curing the multi-layer structure of step (e) to form the phased array antenna that is flexible and conforms to a curvilinear surface.

This brief summary has been provided so that the nature of this disclosure may be understood quickly. A more complete understanding of the disclosure can be obtained by reference to the following detailed description of the various embodiments thereof in connection with the attached drawings.

### BRIEF DESCRIPTION OF THE DRAWINGS

The foregoing features and other features will now be described with reference to e drawings of the various embodiments. In the drawings, the same components have the same reference numerals. The illustrated embodiments are intended to illustrate, but not to limit the present disclosure. The drawings include the following Figures:

FIG. 1A shows a thin flexible phased array antenna mounted on an unmanned air vehicle (UAV), according to one embodiment;

FIG. 1B shows a cross-section of a flexible phased array antenna, according to one embodiment;

FIG. 1C shows a semi-exploded cross-sectional view of the flexible phased array antenna, according to one embodiment;

FIGS. 1F show phased array antenna components during different stages of manufacturing, according to one embodiment; and

FIG. 2 shows a process flow diagram for manufacturing a flexible phased array antenna, according to one embodiment.

### DETAILED DESCRIPTION

Phased array antennas (may also referred to as “PAA”) are widely used in radar systems and communication systems due to the added capability that results from electronically controlled phase shifters provided behind each radiating element. PAAs are typically mounted on a platform that communicates with a satellite or ground station, or that acts as the antenna for a radar system. Platforms (may also be referred to as “vehicles”) include aircrafts, helicopters, satellites, automobiles and any terrestrial or airborne vehicle. For purposes of this disclosure, phased array antennas mounted on fuselage of air vehicles are discussed. It is within the scope of the disclosure to use phased array antenna on any type of vehicle.

PAAs may include a plurality of layers, each layer performing a certain function (structural, electrical, signal, or any other function). The layers may be placed in different ways, depending on how the PAA is used. Furthermore, various topologies and various combinations of materials for layers may be used depending on the desired function of PAA.

Typically, a PAA may include a layer of radiating elements (also referred to as “antennas”) that may include RF electronics associated with transmit-receive modules, a beamformer layer (may also be called a feed layer), a power layer, a control logic layer, and associated support structure. Various layers of PAA may be coupled together, with a subset of active transmitters and receivers and digital samplers.

In one embodiment, a thin, lightweight, and flexible PAA is provided that can be mounted on a curved surface. The PAA is fabricated by a cost-effective process, as described below.

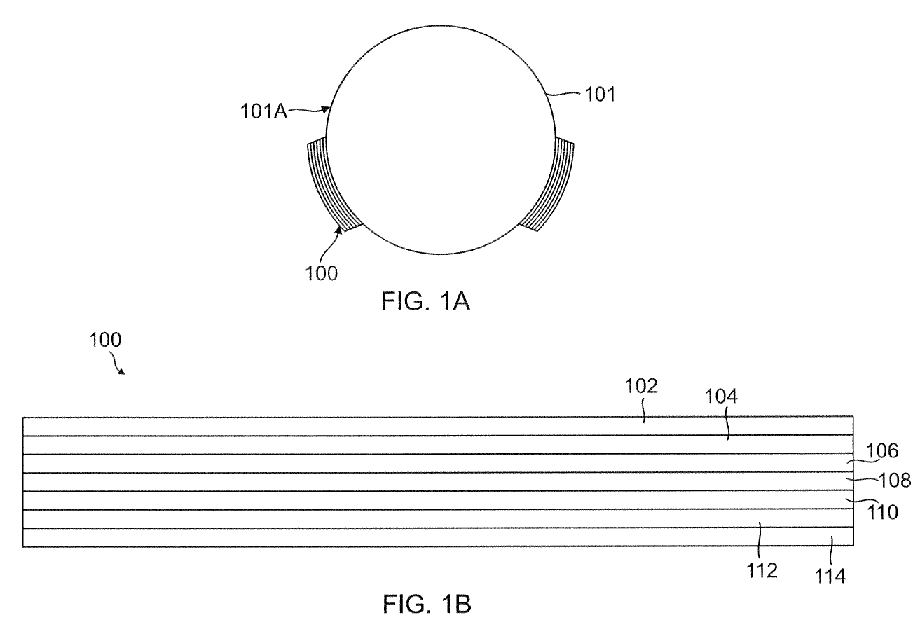

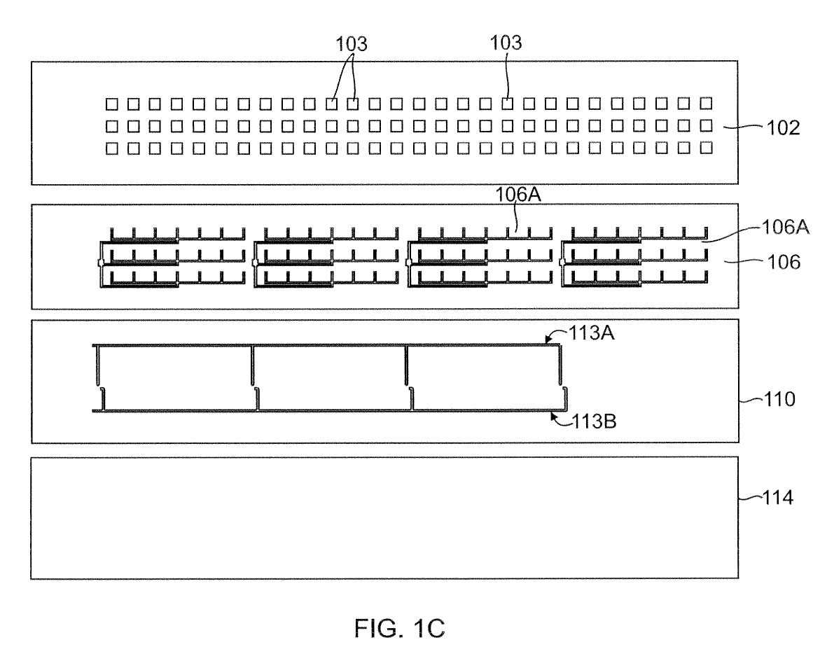

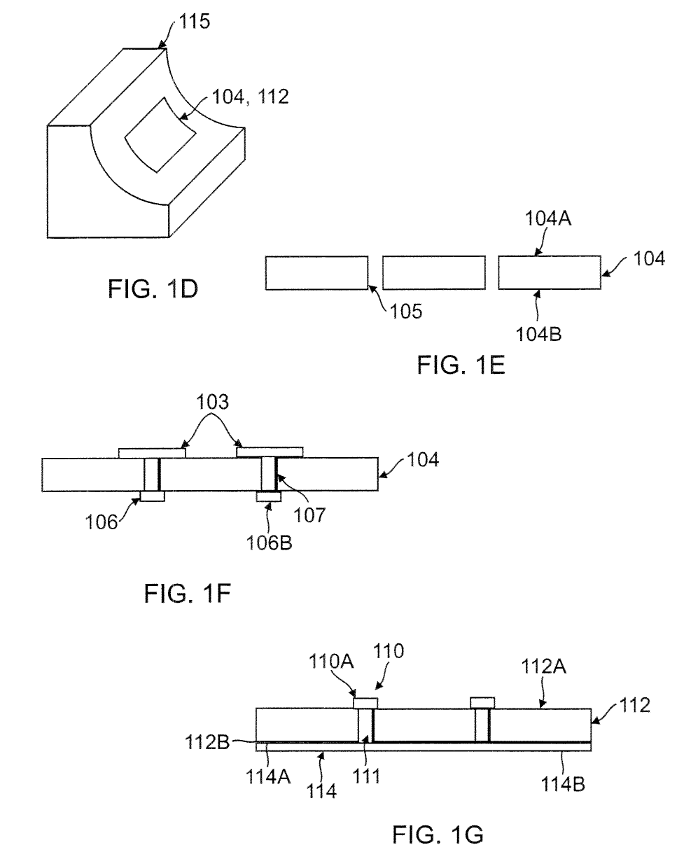

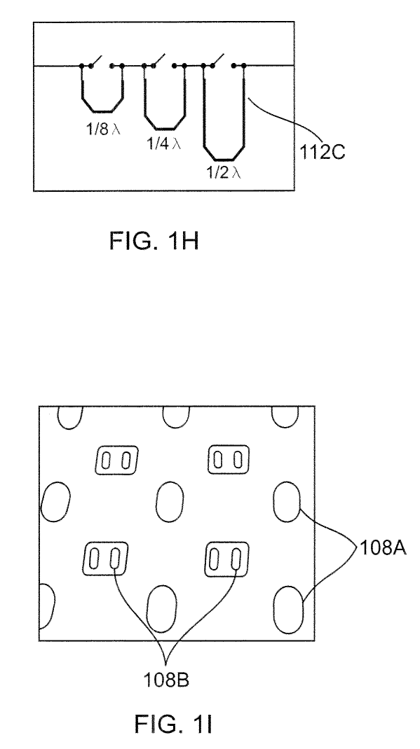

FIG. 1A shows an example of a PAA 100 mounted on a curvilinear surface 101A of an unmanned airborne vehicle (UAV) 101, according to one embodiment. PAA 100 may be planar, with a flexible substrate that is deformed to a curvilinear final shape when bonded to exterior surface 101 of fuselage of UAV 101.

FIG. 1B shows a cross section of PAA 100 having a plurality of layers 102-114. PAA 100 may include a radiating elements layer 102, a dielectric layer 104, a feed layer 106, an adhesive layer 108, a power and control logic layer 110, a second dielectric layer 112, and a ground layer 114.

Radiating elements layer 102 comprises a plurality radiating patch elements 103 (also referred to as “patches”) (Shown in FIG. 1C). The plurality of radiating patch elements 103 enable coupling of microwave signals from PAA 100 to free space, and enables communication of FAA 100 with a transmit source or a receiver (not shown).

In one embodiment, dielectric layer 104 may be a flexible substrate formed of a composite material of ceramic and Teflon commonly available as Duroid™, or liquid crystal polymer. Dielectric layer 104 (also referred to as “LOP layer” or “LOP Layer I” or “layer 104”) provides structural support and isolation/standoff from the radiating patch elements 103. It is to be understood that layer 104 may he formed of any flexible dielectric material that exhibits desired electrical and structural properties. In one embodiment, layer 104 may be formed of a flexible Duroid™ material.

Layer 104 may include a first surface 104A and a second surface 104B, as shown in FIG. 1E. The first surface 104A is placed below layer 102. The second surface 104B (FIG. 1E) of LCP layer 104 rests on a first surface (not shown) of feed layer 106. Layer 104 includes vias 105 between radiating element layer 102 and feed layer 106.

Feed layer 106 provides waveguide corporate feed. Feed layer 106 may be a microstrip, or stripline, or a similar structure known in the art. The topology of feed layer 106 is determined by the desired function and operating parameters of PAA 100.

Feed layer 106 may include power hybrids 106A, as shown in FIG. 1C. Radiating elements 103 are space coupled through microwave vias (shown as 105 in FIG. 1E) through LCP layer 104 to feed layer 106.

A second surface 106B (See FIG. 1F) of feed layer 106, opposite to first surface of the feed layer 106, rests on an adhesive layer 108. Adhesive layer 108 (also referred to as “adhesive”) may be a dielectric material. In one embodiment, the adhesive layer 108 used in PAA 100 may have a thickness of 1 mil (0.001 inch).

Adhesive layer 108 operationally couples feed layer 106 with a first surface 110A (See FIG. 1G) of power and control logic layer (PCL layer) 110.

PCL layer 110 is formed of a flexible material like liquid crystal polymer. PCL layer 110 may include a power source 113A for providing power to antenna electronics. Power source 110A preferably provides direct current (DC) to antenna electronics, for example, phase shifters 112C in the layer 112.

PCL layer 110 may also include control logic 113B for delivering control instructions within PAA 100, including controlling phase shifters 112C in layer 112.

A second surface (not shown) of PCL layer 110, opposite first surface 110A, rests on a first surface 112A of a second dielectric layer 112 (See FIG. 1C). PCL layer 110 may be operationally coupled to the second dielectric layer 112 using vias 111.

In one embodiment, dielectric layer 112 may be a liquid crystal polymer layer (“LOP layer II” or “LOP layer 112”). The front surface 112A of the dielectric surface 112 may also include phase shifters (112C). Phase shifters 112C may be deposited on the front surface 112A by an additive process, or may be provided in the form of a Micro-Electro-Mechanical Systems (MEMS) switch.

A second surface 112B of LOP layer 112 rests on a first surface 114A of a ground layer 114. A second surface (114B) of ground layer 114 forms a bond interface between PAA 100 and the curvilinear surface 101A of UAV 101. A structural adhesive placed between the ground layer 114 and curvilinear surface 101A facilitates bonding of the PAA 100 on the UAV surface 101A. Ground layer 114 is a conductive layer formed of a conductive material known in the art. Preferably, ground Layer 114 is formed of copper.

FIG. 10 shows a semi-exploded view of some of the layers (102, 106, 110 and 114) of PAA 100. PAA 100 may be a planar unit that accommodates the internal shear loads associated with deformation of the planar, flexible PAA 100 to conform the final radius of curvature defined by the outer contour of the platform, i.e. 101.

In one embodiment PAA 100 may be formed by an additive process, for example, the Direct Write process. In the Direct Write process, PAA elements may be thermally sprayed to a desired substrate to form a desired end product.

In one embodiment, a flexible PAA 100 is fabricated by spraying various layers of PAA 100 onto structural layers (for example, LCP Layer I and II, 104 and 112). The various layers are placed in desired proportions and spaced at desired intervals on a ground layer. The layers are operationally coupled by adhesive layer 108.

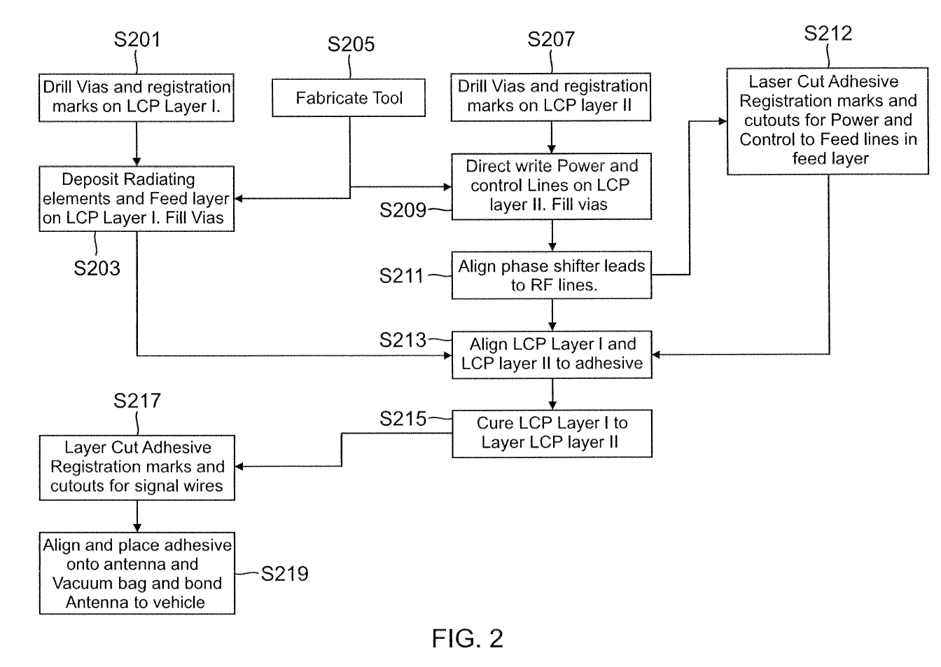

FIG. 2 shows an example of the process steps for forming a planar and flexible PAA 100, according to one embodiment. The process steps for forming PAA 100 are described with reference to FIG. 1D-1F, where various components of PAA 100 during different stages of manufacturing are shown.

The process begins in block S201, when vias (105) and registration marks are drilled on LCP layer 104. Vias 105 (FIG. 1E) are drilled or laser ablated to allow deposition of conductive material 107 that allow passage of electromagnetic radiation within various layers of PAA 100. The conductive material may be deposited using the direct write process through the use of conductive epoxy. Registration marks facilitate alignment of various layers of PAA 100 in a desired configuration. FIG. 1E show a LCP layer 104 with drilled vias 105.

In block S203, radiating elements (or patches) 103 are deposited onto the LCP layer 104. Vias 105 are then filled with conductive material 107 followed by printing feed traces (106) on the LOP layer 104. FIG. 1F shows a LCP layer 104 with filled vias 107, deposited patches 103 and printed feed traces 106 on the LCP layer 104.

In one embodiment, a curved tool 115 (see FIG. 10) is fabricated in block S205, and radiating elements 103 and feed layer (106) are deposited on LOP layer 104 while the LCP layer 104 is placed on tool 115. Use of curved tool flows for formation of a planar, flexible and non-rigid structure of PAA 100.

In block S207, vias are drilled layer 112 and registration marks are also placed on LCP layer 112. Block S207 is similar to block S201. Vias may be drilled or laser ablated through the LOP layer 112 up to the ground layer 114 to allow for conductive material to be deposited. Registration marks (not shown) formed on the LOP 114 enables aligning he LOP layers (112 and 104) and the adhesive layer 108. LCP layer 112 may include electrodeposited copper on surface 112B.

In block S209, LCP layer 112 is placed on the curved tool 115 (formed in block S205), and power and control lines are formed on the LOP layer 112. Power and control lines are written by additive methods, for example, the Direct Write.

Further, in block 8209, while resting the LOP layer on the curved tool 115, vias are filled with conductive material. FIG. 1G shows LOP layer 112 with filled vias (111), power and control logic layer 110 written on a first surface of LOP layer 112, resting on the ground layer 114.

In block S211, phase shifter leads and RF lines in the PCL layer 112 are aligned to the desired combination as shown in FIG. 1H.

The process then moves to block S212 where adhesive registration marks 108A are laser cut on LCP layer 104 and LCP layer 112. Cutouts 108B are also made to enable supply of power and control through PCL layer 110 to feed layer 106. FIG. 11 shows an example of adhesive registration marks 108A and cutouts 108B.

In block S213, LCP layers 104 and 112 are aligned via registration marks 108A. Adhesive 108 is placed at the designated registration marks 108A and LCP layer I 104 and LCP layer II 112 are coupled together.

In block S215, coupled LCP layers 104 and LCP layer 112 of PAA 100 are cured and vacuum bagged m PAA 100.

In block S217, adhesive registration marks and cutouts for signal wires are made on PAA 100 that enables aligning and placing of PAA 100 with its support structure. In block S219, PAA 100 is vacuum bagged and, with the addition of an adhesive, bonded to outer surface of vehicle 101.

PAA 100 formed by direct write process enables usage of functional materials, e.g. copper, only where they are needed. This reduces waste in terms of raw materials. PAA 100 formed by direct write process has efficient packaging and integration of electronics functionality without adversely effecting weight and thickness. PAA 100 is therefore planar and light weight and deforms to a curvilinear final shape when bonded to an air vehicle exterior skin (for example, 101, FIG. 1A).

PAA 100 is planar and may be deformed to a curvilinear final shape when bonded to the air vehicle (101) exterior skin. PAA 100 is light weight and consumes relatively less power than available alternatives. PAA 100 parasitically realizes structural rigidity by bonding to aircraft 101 structures instead of the customary procedure of designing dedicated antenna structural component.

PAA 100 has enhanced capabilities and exhibits high directivity for radar or communications functions. It enables communications bandwidths that permit more data to be transmitted or received, because antenna directivity and link signal-to-noise ratios.

Although the present disclosure has been described with reference to specific embodiments, these embodiments are illustrative only and not limiting. Many other applications and embodiments of the present disclosure will be apparent in light of this disclosure and the following claims.

What is claimed is:

1. A phased array antenna, comprising:
a plurality of layers fabricated using an additive process such that the phased array antenna conforms to a curvilinear surface; wherein the plurality of layers include:
a radiating layer placed on a first surface of a dielectric layer;
a feed layer operationally coupled to a second surface of the first dielectric layer; and
a second dielectric layer having a first surface operationally coupled to a power and control layer and second surface operationally coupled to a ground layer;
wherein an adhesive layer operationally couples the feed layer to the power and control layer.

2. The phased array antenna of claim 1, wherein the first dielectric layer and the second dielectric layer are formed of liquid crystal polymer.

3. The phased array antenna of claim 1, wherein the radiating layer includes radiating elements additively deposited on first surface of the first dielectric layer.

4. The phased array antenna of claim 1, wherein the radiating layer is deposited directly on the first dielectric layer.

5. The phased array antenna of claim 1, wherein the second surface of the second dielectric layer rests on the ground layer.

6. The phased array antenna of claim 1, wherein the power and control layer is deposited directly on the second dielectric layer.

7. A phased array antenna, comprising:
a plurality of layers fabricated using an additive process such that the phased array antenna conforms to a curvilinear surface; wherein the plurality of layers include:
a radiating layer placed on a first surface of a first dielectric layer;
a feed layer operationally coupled to a second surface of the first dielectric layer; and
a second dielectric layer having a first surface operationally coupled to a power and control layer and second surface operationally coupled to a ground layer;
wherein an adhesive layer operationally couples the feed layer to the power and control layer;
wherein the first dielectric layer and the second dielectric layer are formed of liquid crystal polymer; and
wherein the radiating layer includes radiating patch elements additively deposited directly on the first surface of the first dielectric layer.

8. The flexible phased array antenna of claim 8, wherein the second surface of the second dielectric layer rests on the ground layer.

9. The flexible phased array antenna of claim 9, wherein the power and control layer is deposited directly on the second dielectric layer.

10. A method for fabricating a phased array antenna, comprising:
(a) depositing radiating elements on a first surface of a first dielectric layer;
(b) depositing a feed layer on a second surface of the first dielectric layer;
(c) depositing a power and control logic layer on a first surface of a second dielectric layer, and depositing a substrate layer on the second surface of the second dielectric layer;
(d) coupling the first dielectric layer with the deposited feed layer and radiating elements of step (b) with the second dielectric layer, such that a surface of the feed layer couples to a surface of the power and control logic layer with a structural adhesive to form a multi-layer structure; and
(e) curing the multi-layer structure of step (e) to form the phased array antenna that is flexible and conforms to a curvilinear surface.

11. The method of claim 11, wherein the radiating elements are deposited by an additive process.

12. The method of claim 12, wherein the additive process is direct write process.

13. The method of claim 11, wherein the feed layer is deposited by an additive process.

14. The method of claim 14, wherein the additive process is direct write process.

15. The method of claim 11, wherein step (d) of claim 11 uses an adhesive layer between the first dielectric layer and the second dielectric layer.
